(19) United States
(12) Patent Application Publication
(10) Pub. No.: US 2012/0037691 A1
(43) Pub. Date: Feb. 16, 2012

(54) FOOD CARTON

(76) Inventors: James A. Hubbard, JR., Oak Lawn, IL (US); Matthew R. Cook, Hinsdale, IL (US); Thomas Fu, Naperville, IL (US)

(21) Appl. No.: 12/856,385

(22) Filed: Aug. 13, 2010

(51) Int. Cl. B65D 5/00; B31B 1/00; B65D 43/00

(52) U.S. Cl. 229/120; 229/124; 493/52; 493/84

(57) ABSTRACT

A food carton includes a substantially triangular bottom panel with a first, second and third edge. A first, second, and third sidewall connect to the first, second, and third edge, respectively, of the bottom panel. A cover is connected to a top edge of the third sidewall. The bottom panel; first, second, and third sidewalls; and the cover define a substantially closed space therein in a closed configuration. In the closed configuration, a first side edge and a second side edge of the third sidewall extend beyond a rear edge of the first sidewall and a rear edge of the second sidewall, respectively, so that the rear edge of the first sidewall and the rear edge of the second sidewall are in frictional contact with an inner surface of the third sidewall.

### FIELD OF APPLICATION

This application relates to food cartons. Specifically, this application relates to a food carton that maintains a closed configuration without the use of adhesives.

### BACKGROUND

Food cartons, such as those provided to customers of a restaurant, are utilized to store food items and to enable transportation of the food items. In some instances, the cartons may be sized to match a specific food item. For example, a carton for storing a slice of pizza may have a generally triangular shape.

Food cartons may be shipped to the restaurant in a preassembled configuration or in an unassembled configuration. The unassembled configuration enables more compact shipment of the cartons. In this configuration, the carton may correspond to a sheet of material with various cuts and fold lines that define the various faces of the carton. The sheet of material may include flaps at certain regions with an adhesive that enables forming the carton.

### BRIEF SUMMARY

A food carton includes a substantially triangular bottom panel with a first, second and third edge. A first, second, and third sidewall connect to the first, second, and third edge, respectively, of the bottom panel. A cover is connected to a top edge of the third sidewall. The bottom panel; first, second, and third sidewalls; and the cover define a substantially closed space therein in a closed configuration. In the closed configuration, a first side edge and a second side edge of the third sidewall extend beyond a rear edge of the first sidewall and a rear edge of the second sidewall, respectively, so that the rear edge of the first sidewall and the rear edge of the second sidewall are in frictional contact with an inner surface of the third sidewall.

Other features and advantages will be, or will become, apparent to one with skill in the art upon examination of the following figures and detailed description. It is intended that all such additional features and advantages included within this description be within the scope of the invention, and be protected by the following claims.

### BRIEF DESCRIPTION OF THE DRAWINGS

The accompanying drawings are included to provide a further understanding of the claims, are incorporated in, and constitute a part of this specification. The detailed description and illustrated embodiments described serve to explain the principles defined by the claims.

FIG. 1A illustrates a perspective view of a food carton;

FIG. 1B illustrates a plan view of a sheet of material that may be formed into the food carton of FIG. 1A;

FIG. 2 illustrates operations for assembling the sheet of material of FIG. 1B to form the carton of FIG. 1A;

FIG. 3A illustrates a tapered sidewall of the food carton; and

FIG. 3B illustrates a group of food cartons in a stacked configuration.

### DETAILED DESCRIPTION OF THE DRAWINGS

The exemplary embodiments below describe a food carton for storing a food item, such as a slice of pizza. Generally, the food carton is formed from a sheet of material that defines a bottom panel; a first, second, and third sidewall; and a cover. The bottom panel; first, second, and third sidewall; and the cover are configured to be folded about various foldable edges to form the carton. The carton is configured to maintain a closed configuration without the use of adhesives and is further configured to substantially prevent juices, crumbs, and the like from exiting an interior space defined by the bottom panel; first, second, and third sidewall; and the cover.

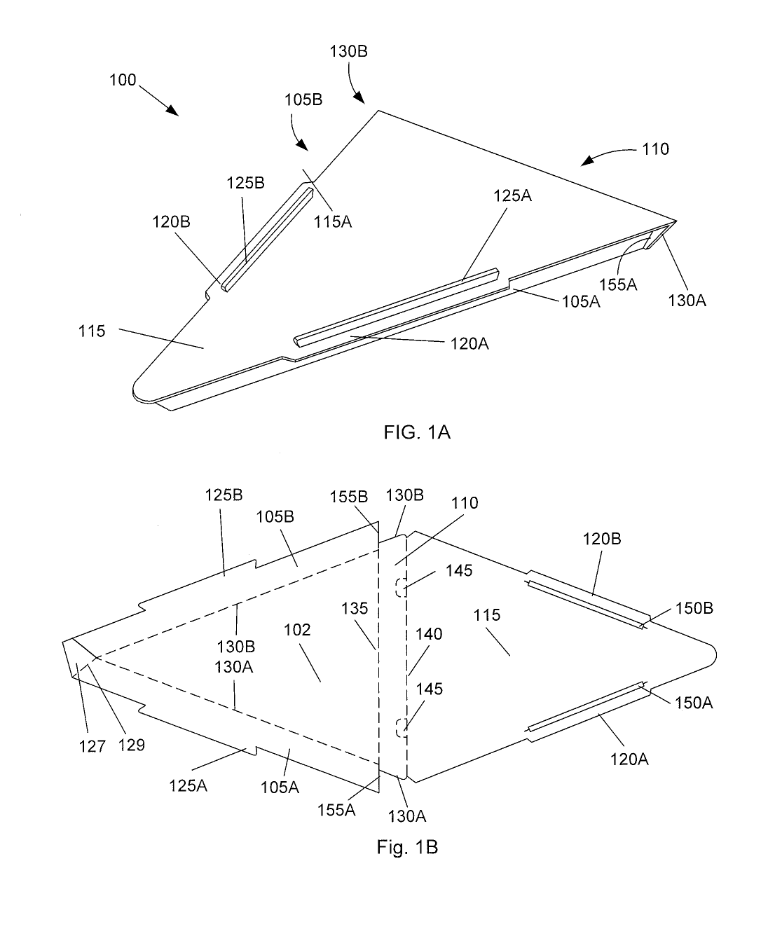

FIG. 1A illustrates a perspective view of a food carton 100, hereinafter referred to as the carton 100. FIG. 1B illustrates a plan view of a sheet of material that may be formed into the carton 100 of FIG. 1A. The sheet of material may correspond to a corrugated paper material or a different material suitably rigid for storing food items. An F-fluted sheet of material may be utilized to improve heat retention of the carton. In the plan view, dashed lines correspond to fold lines and solid lines are cuts.

The carton 100 includes a substantially triangular bottom panel 102 (FIG. 1B), a first sidewall 105A, a second sidewall 105B, a third side wall 110, and a cover 115. The first sidewall 105A and the second sidewall 105B are connected to a first and second foldable edge 130A and 130B, respectively, of the bottom panel 102. The first sidewall 105A may include a flap member 127 connected to a forward foldable edge 129 that is configured to be folded inwardly against an inner surface of the second sidewall 105B.

The third sidewall 110 is connected to a third foldable edge 135 of the panel 102. The cover 115 is connected to a top foldable edge 140 of the third sidewall 110.

A first and second tab 125A and 125B extend from a top edge of the first sidewall 105A and the second sidewall 105B, respectively. The first and second tab 125A and 125B may be substantially centered along the respective top edges. The cover 115 defines a first and second slot 150A and 150B substantially adjacent to first and second edges of the cover 150 that are positioned and sized to receive the first and second tab 125A and 125B, respectively.

In some implementations, the cover may define a first and second extension region 120A and 120B on the first and second edges, positioned adjacent to the first and second slots 150A and 150B. The first and second extension regions 120A and 120B may compensate for any loss in structural integrity of the cover 115 associated with the first and second slots 150A and 150B and may lessen the possibility of a slot 120A and 120B tearing.

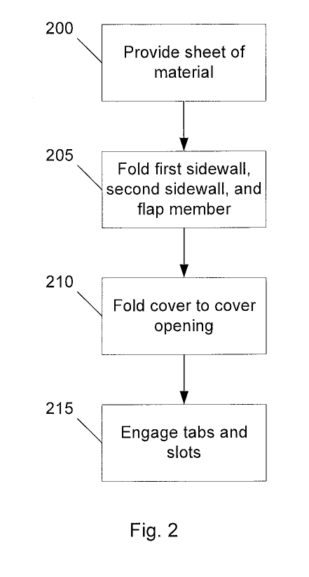

FIG. 2 illustrates operations for assembling the carton 100. In the assembled configuration, the bottom panel 102, first sidewall 105A, second sidewall 105B, and third sidewall 110 form a space within which a food item may be placed. For example, a slice of pizza may be placed within the space. At block 200, a sheet of material that defines the bottom panel 102, first sidewall 105A, second sidewall 105B, third sidewall 110, and the cover 115 may be provided.

At block 205, the flap member 127, the first sidewall 105A and the second sidewall 105B are simultaneously folded in an inward direction, so that the flap member 127 comes to rest against an inner surface of the second sidewall 105B.

At block 210, the cover 115 may be folded about the top edge 140 of the third sidewall 110.

At block 215, the first and second tabs 125A and 125B may be inserted into the first and second slots 150A and 150b to place the carton 100 in a closed configuration. The first and second tabs 125A and 125B may be configured to releasably lock the cover 115 in the closed configuration and to maintain the first and second sidewalls 105A and 105B in a folded configuration.

Referring back to FIGS. 1A and 1B, in the closed configuration, a first side edge 130A and a second side edge 130B of the third sidewall 110 extend beyond a rear edge 155A of the first sidewall 105A and a rear edge 155B of the second sidewall 105B, respectively, so that the rear edge 155A of the first sidewall 105A and the rear edge 155B of the second sidewall 105B come into direct contact with an inner surface of the third sidewall 110.

In some implementations, the first and second tabs 125A and 125B and the first and second slots 150A and 150b are positioned so that gaps that may otherwise exist between the respective rear edges 155a and 115B and the surface of the third sidewall 110 are eliminated. In other words, the first and second tabs 125A and 125B and the first and second slots 150A and 150b cooperate to pull the respective rear edges 155A and 155B snugly against the inner surface so that no gaps exist and so that frictional forces between the rear edges 155A and 155B and the inner surface prevent substantial movement of the rear edges 155A and 155B. The tight fit between the rear edges 155A and 155B and the inner surface may prevent juices, crumbs, and the like from exiting the carton 100. The flap member 127 may similarly prevent juices, crumbs, and the like from exiting from a forward end of the carton 100 by virtue of the resilient force holding the flap member 127 against the inner surface of the second sidewall 105B. Thus, the carton 100 advantageously prevent juices from leaking out without the need for adhesives of any kind.

In some implementations, the third sidewall 110 may define one or more ventilation cutouts 145. The ventilation cutouts 145 are configured to be opened to enable ventilation of the closed space in the closed configuration. For example, the ventilation cutouts may be popped out to enable ventilation of the carton 100.

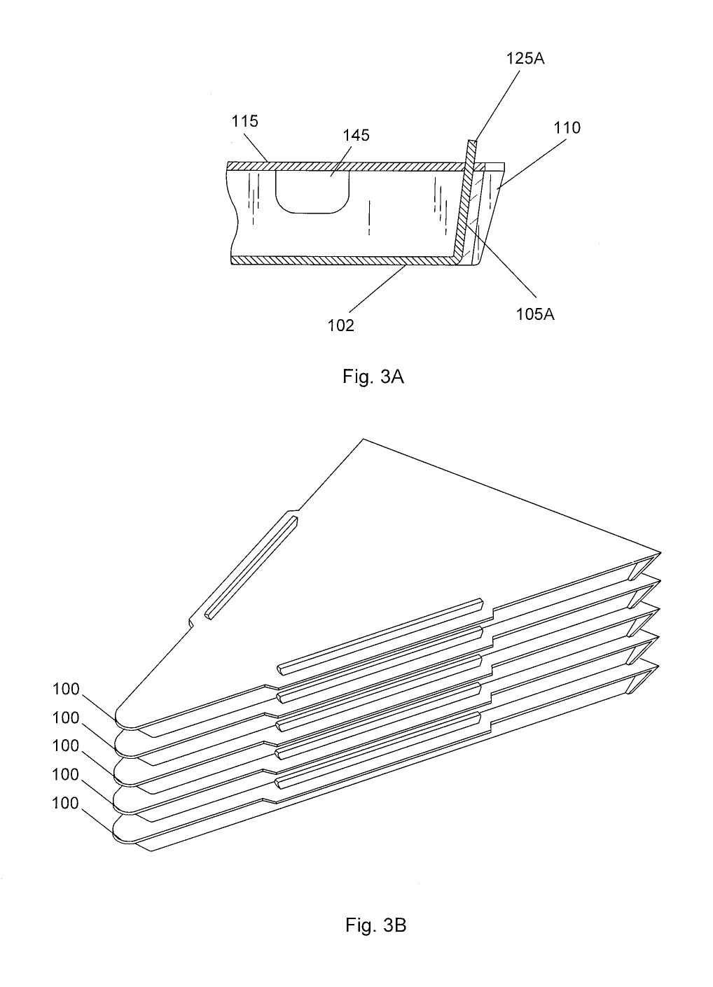

Referring to FIG. 3A, in yet other implementations, the first sidewall 105A and second sidewall 105B are tapered. Tapering of the sidewalls 105A and 105B enables, for example, stacking of the cartons 100 without staggering the cartons 100, as shown in FIG. 3B.

While various embodiments of the invention have been described, it will be apparent to those of ordinary skill in the art that many more embodiments and implementations are possible that are within the scope of the invention. Accordingly, it will be apparent to those of ordinary skill in the art that many more embodiments and implementations are possible that are within the scope of the claims. Therefore, the embodiments described are only provided to aid in understanding the claims and do not limit the scope of the claims.

We claim:

1. A food carton comprising:
a substantially triangular bottom panel with a first, second and third edge;
first, second, and third sidewalls connected to the first, second, and third edge, respectively; and
a cover joined to a top edge of the third sidewall, wherein the bottom panel; first, second, and third sidewalls; and the cover define a substantially closed space therein in a closed configuration,
wherein in the closed configuration, a first side edge and a second side edge of the third sidewall extend beyond a rear edge of the first sidewall and a rear edge of the second sidewall, respectively, so that the rear edge of the first sidewall and the rear edge of the second sidewall are in frictional contact with an inner surface of the third sidewall.

2. The food carton according to claim 1, wherein the food carton is maintained in the closed configuration without the use of adhesives.

3. The food carton according to claim 1, further comprising a flap member connected to a forward edge of the first sidewall configured to be folded inwardly against an inner surface of the second sidewall in the closed configuration.

4. The food carton according to claim 1, further comprising first and second tabs that extend from a top edge of the first and second sidewalls, respectively, configured to enter first and second slots, respectively, defined by the cover, wherein the first and second tabs and the first and second slots cooperate to secure the cover in the closed configuration.

5. The food carton according to claim 4, wherein the cover defines first and second extension regions on a first and a second edge positioned adjacent to the first and second slots.

6. The food carton according to claim 1, wherein the third sidewall defines at least one ventilation cutout configured to be opened to enable ventilation of the closed space in the closed configuration.

7. The food carton according to claim 1, wherein the first and second sidewall are tapered to enable stacking of the food carton such that a bottom surface of the bottom panel of a first food carton contacts a top surface of the cover of a second carton, and such that the first and second food carton are not staggered in relation to one another.

8. The food carton according to claim 1, wherein carton comprises a corrugated material.

9. A method of manufacturing a food carton comprising:
forming a substantially triangular bottom panel with a first, second and third edge;
forming first, second, and third sidewalls that connect to the first, second, and third edge, respectively; and
forming a cover that joins a top edge of the third sidewall,
wherein the bottom panel; first, second, and third sidewalls; and the cover define a substantially closed space therein in a closed configuration,
wherein in the closed configuration, a first side edge and a second side edge of the third sidewall extend beyond a rear edge of the first sidewall and a rear edge of the second sidewall, respectively, so that the rear edge of the first sidewall and the rear edge of the second sidewall are in frictional contact with an inner surface of the third sidewall.

10. The food carton according to claim 9, wherein the food carton is maintained in the closed configuration without the use of adhesives.

11. The food carton according to claim 9, further comprising forming a flap member on a forward edge of the first sidewall, wherein the flap member is configured to be folded inwardly against an inner surface of the second sidewall in the closed configuration.

12. The food carton according to claim 9, further comprising:
forming first and second tabs that extend from a top edge of the first and second sidewalls, respectively; and
forming first and second slots, respectively, on the cover, wherein the first and second tabs and the first and second slots are configured to cooperate so as to secure the cover in the closed configuration.

13. The food carton according to claim 4, wherein the cover defines first and second extension regions on a first and a second edge positioned adjacent to the first and second slots.

14. The food carton according to claim 9, wherein the third sidewall defines at least one ventilation cutout configured to be opened to enable ventilation of the closed space in the closed configuration.

15. The food carton according to claim 9, wherein the first and second sidewall are tapered to enable stacking of the food carton such that a bottom surface of the bottom panel of a first food carton contacts a top surface of the cover of a second carton, and such that the first and second food carton are not staggered in relation to one another.

16. A method for assembling a food carton, the method comprising:
providing a sheet of material that defines:
a substantially triangular bottom panel with a first, second and third foldable edge;
first, second, and third sidewalls connected to the first, second, and third foldable edge, respectively, wherein the first and second sidewalls each define a tab;
a flap member connected to a forward foldable edge of the first sidewall configured to be folded inwardly against an inner surface of the second sidewall; and
a cover joined to a top foldable edge of the third sidewall, wherein the cover defines a first and second slot configured to receive the first and second tab, respectively;
simultaneously folding the first and second sidewalls, and the flap member in an inward direction; and
folding the cover about the top foldable edge of the third sidewall until the first and second tabs engage the first and second slots,
wherein the bottom panel; first, second, and third sidewalls; and the cover define a substantially closed space therein in a closed configuration,
wherein in the closed configuration, a first side edge and a second side edge of the third sidewall extend beyond a rear edge of the first sidewall and a rear edge of the second sidewall, respectively, so that the rear edge of the first sidewall and the rear edge of the second sidewall are in frictional contact with an inner surface of the third sidewall.

17. The food carton according to claim 16, wherein the food carton is maintained in the closed configuration without the use of adhesives.

18. The food carton according to claim 16, wherein the cover defines first and second extension regions on a first and a second edge positioned adjacent to the first and second slots.

19. The food carton according to claim 16, wherein the third sidewall defines at least one ventilation cutout configured to be opened to enable ventilation of the closed space in the closed configuration.

20. The food carton according to claim 16, wherein the first and second sidewall are tapered to enable stacking of the food carton such that a bottom surface of the bottom panel of a first food carton contacts a top surface of the cover of a second carton, and such that the first and second food carton are not staggered in relation to one another.
